(19) United States
(12) Patent Application Publication
(10) Pub. No.: US 2013/0169938 A1
(43) Pub. Date: Jul. 4, 2013

(54) COLOR WHEEL WITH FAN BLADE

(71) Applicants: KAI HUANG, Tu-Cheng (TW); Ming-Chih Sun, Tu-Cheng (TW)

(72) Inventors: KAI HUANG, Tu-Cheng (TW); Ming-Chih Sun, Tu-Cheng (TW)

(73) Assignee: HON HAI PRECISION INDUSTRY CO., LTD., Tu-Cheng (TW)

(21) Appl. No.: 13/517,701

(22) Filed: Jun. 14, 2012

(30) Foreign Application Priority Data
Dec. 29, 2011 (TW) 100149676

(51) Int. Cl. G03B 21/14

(52) U.S. Cl. 353/31

(57) ABSTRACT

A color wheel unit of a projector includes a motor and a color wheel. The color wheel is synchronized with the rotating motion of the motor. The color wheel has a light-irradiated area and a non-irradiated area. The light-irradiated area is positioned in an outer margin of the color wheel and at least a phosphor layer is located on the light-irradiated area. The non-irradiated area is positioned at the inner portion of the color chip. A number of fan blades are located in the non-irradiated area. The fan blades are synchronized with the rotating motion of the color wheel that generates air flow to enhance heat dissipation efficiency of the color wheel.

### BACKGROUND

1. Technical Field

The disclosure is related to a color wheel unit, and particularly to a color wheel unit having fan blades for improving heat dissipation efficiency.

2. Description of Related Art

Light sources of current projectors, such as high-pressure mercury-vapor lamp, tungsten-halogen lamps, and metal-halogen lamps, are known to consume high power, with a short lifetime, as well they are bulky, and generate high heat. Not only light sources but also other components, such as color wheel illuminated by light sources, are heat generators. Color wheel units are driven by motors. Radiation of light from the light source accumulates heat on the color wheel. Both active motors and passive color wheels produce heat and require heat dissipation devices to cool down. These heat-generating devices need cooling devices for heat dissipation. However, the color wheel units of current projectors are used to filter light of different colors and have no independent cooling devices for the color wheels. Therefore, heat dissipation efficiency of the color wheel units for current projectors needs to be improved.

### BRIEF DESCRIPTION OF THE DRAWINGS

The components in the drawings are not necessarily drawn to scale, the emphasis instead being placed upon clearly illustrating the principles of a color wheel unit. Moreover, in the drawings, like reference numerals designate corresponding parts throughout the several views.

FIG. 1 is a front view diagram showing a color wheel unit.

FIG. 2 is an assembly diagram showing a color wheel and a motor.

FIG. 3 is a back view diagram of the color wheel unit in FIG. 1.

FIG. 4 is a schematic diagram showing light paths of the color wheel unit positioned between a laser light source and a lens module.

### DETAILED DESCRIPTION

The present disclosure will be described with references to the accompanying diagrams.

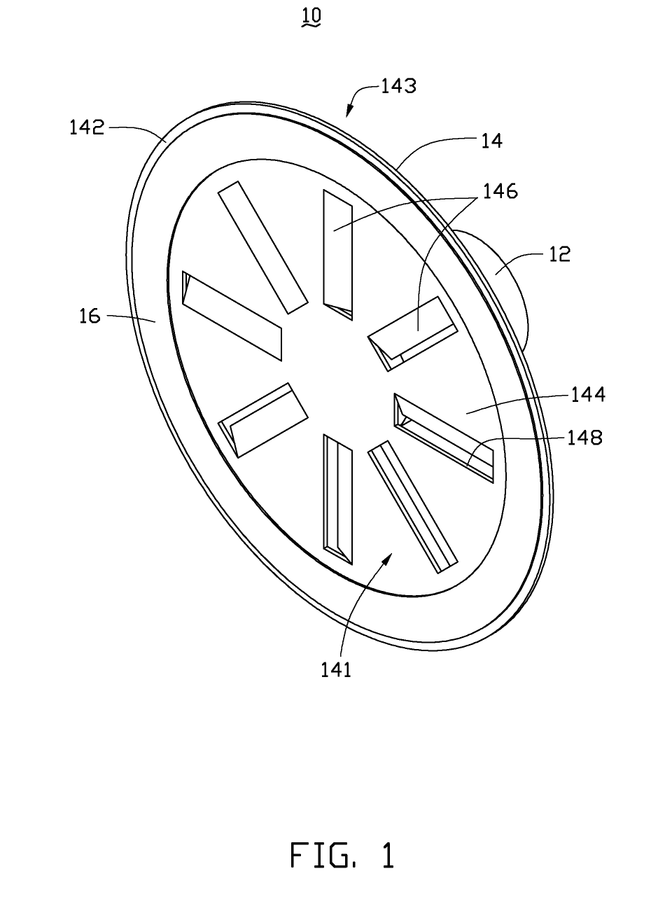

FIG. 1 shows a color wheel unit 10 of the disclosure. The color-wheel unit 10 includes a motor 12 and a color wheel 14. The color wheel 14 has two surfaces, a light-irradiated surface 141 to receive lights and a non-irradiated surface 143 opposite to the light-irradiated surface 141. The color wheel 14 has a light-irradiated area 142 and a non-irradiated area 144. The light-irradiated area 142 is positioned in an outer margin of the color wheel 14. The color wheel 14 has at least one phosphor layer 16 in the light-irradiated area 142. In the present embodiment, the phosphor layer 16 has a circular shape. The phosphor layer 16 may include a plurality of phosphor pieces discontinuously arranged in the light-irradiated area 142. A plurality of fan blades 146 are located in the non-irradiated area 144, which is positioned in an inner margin of the color wheel 14.

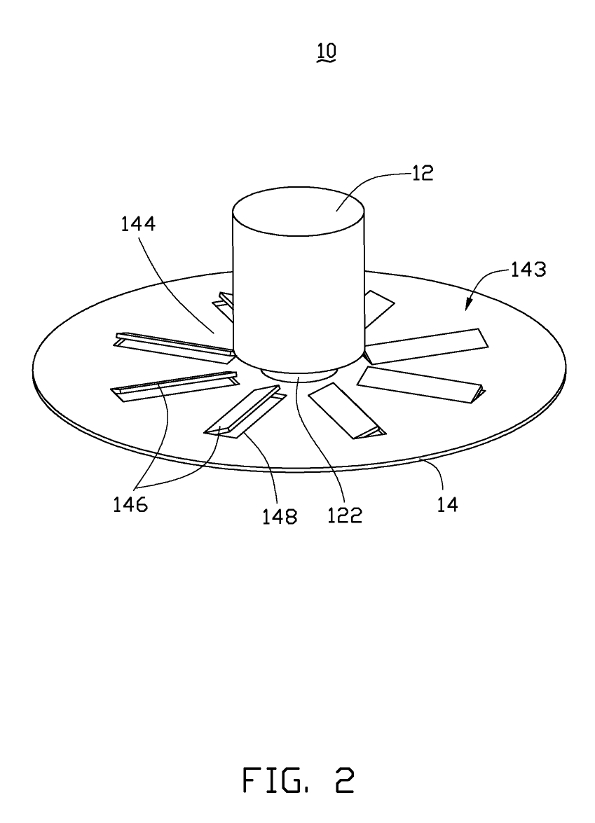

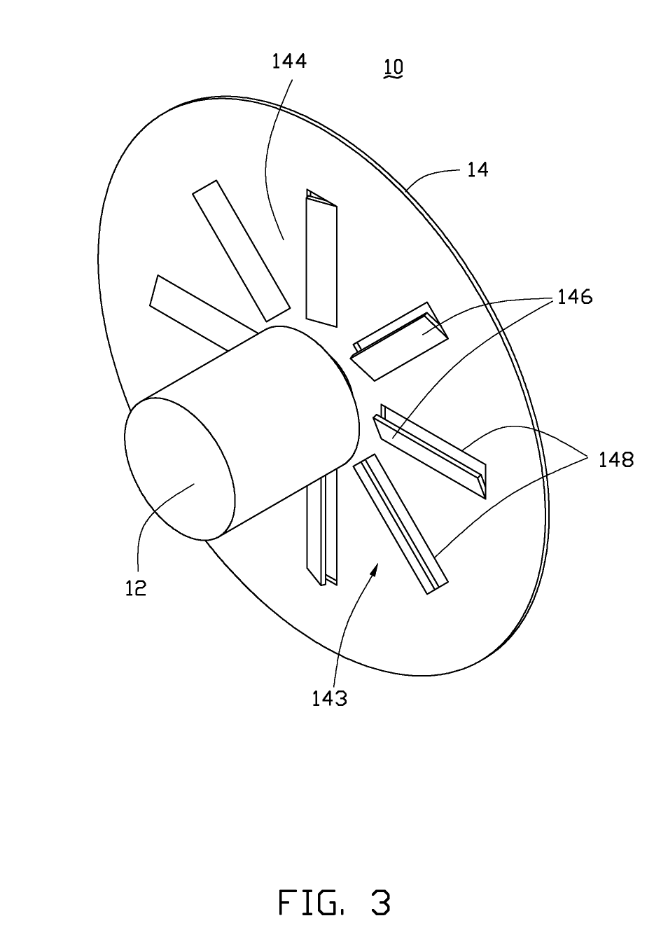

The color wheel 14 is connected to the motor 12 through an axle 122 (see FIG. 2). The axle 122 is tightly attached to a center of the non-irradiated surface 143. The color wheel 14 is synchronized with the rotating motion of the motor 12. The fan blades 146, which are projected from the non-irradiated surface 143, generate air flows when synchronously rotating with the color wheel 14. The air flows help to remove the extra heat from the motor 12 or the color wheel 14 to improve heat dissipation efficiency of the projector. The fan blades 146 of the present embodiment and the color wheel 14 are formed as a single unit. The fan blades 146 are radially arranged on the color wheel 14. The included angle between any two adjacent fan blades 146 is constant. The fan blade 146 may be projected from the non-irradiated surface 143 (as shown in FIGS. 1-3) or from the light-irradiated surface 141. In addition, each fan blade 146 may be added to the color wheel 14 rather than constructed with the color wheel 14 as the single unit as shown in the present embodiment.

The color wheel 14 of the present embodiment is made of metal. The fan blades 146 of the color wheel 14 are formed by cutting the color wheel 14 in the non-irradiated area 144 and then bending the cut pieces. The fan blades 146 and a plurality of openings 148 corresponding to the fan blades 146 are formed. The strength of the air flow induced by the fan blades 146 is determined by the included angle between the color wheel 14 and each fan blade 146. The larger included angle means, the greater the air flow induced by the fan blades 146. The included angle between each fan blade 146 and the color wheel 14 may be modified according to the cooling device of the projector. The direction that the fan blades 146 are bent also determines the direction of the air flow. When the fan blades 146 are bent to project from the light-irradiated surface 141, air flow is formed on the light-irradiated surface 141 to remove heat. On the other hand, when the fan blades 146 are bent to project from the non-irradiated surface 143, air flow is formed to remove heat generated by the motor 12. Furthermore, the air flow may be introduced or discharged by rotating the motor 12 clockwise or counterclockwise.

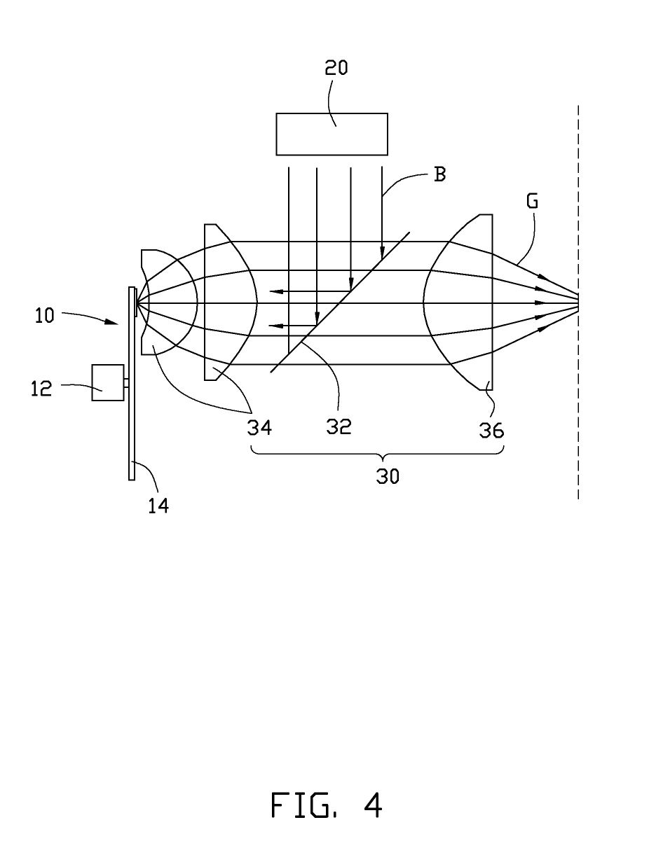

The color wheel unit 10 of the disclosure is arranged in a light path between a laser light source 20 and a lens module 30 (see FIG. 4). The color wheel unit 10 is positioned beside the laser light source 20. The lens module 30 is positioned in front of the color wheel unit 10. The laser light source 20 provides laser beams that pass through the lens module 30 and is transmitted to the color wheel unit 10. The lens module 30 guides the laser beams to illuminate the color wheel unit 10. The lens module 30 includes a dichroic prism 32 and at least two lenses 34, 36. The dichroic prism 32 is sandwiched between the lenses 34, 36. The lenses 34, 36 may be a piece of optical lens or a set of lenses. In the present embodiment, the lenses 34 are a set of lenses including two pieces of optical lenses, and the lens 36 is a piece of optical lens. In the present embodiment, the laser light source 20 generates a light beam, for instance a first color light B. The first color light B from the laser light source 34 enters the dichroic prism 32 and is reflected by the dichroic prism 32 to the color wheel 14. The light-irradiated area 142 is illuminated by the first color light B from the laser light source 20 and the phosphor layer 16 is activated by the first color light B to emit a second color light G. The second color light G successively passes through the lenses 34, the dichroic prism 32 and the lens 36. In the present embodiment, the first color light B is blue, and the second color light G is green. The second color G may be further modified to other colors by a display chip in the follow-up devices of the projector.

During operation, extra heat may be generated by the rotation of the motor 12, or by the light beams illuminating the phosphor layer 16. The color wheel unit 10 of the disclosure has the fan blades 146 arranged in the non-irradiated area 144, which are synchronized with the rotation of the color wheel 14 to form air flow to remove heat from the light-irradiated surface 141 and the motor 12. The fan blades 146 work independently or cooperate with the cooling device of the projector to improve heat dissipation efficiency of the projector.

Although the present disclosure has been specifically described on the basis of this exemplary embodiment, the disclosure is not to be construed, as being limited thereto. Various changes or modifications may be made to the embodiment without departing from the scope and spirit of the disclosure.

What is claimed is:

1. A color wheel unit, comprising:
a motor; and
a color wheel connected to the motor and synchronously rotating with the motor, the color wheel comprising:
a light-irradiated area located at an outer margin of the color wheel;
a non-irradiated area located at an inner margin of the color wheel;
at least a phosphor layer located in the light-irradiated area; and
a plurality of fan blades located in the non-irradiated area.

2. The color wheel unit of claim 1, wherein the motor and the color wheel are positioned in a light pathway between a laser light source and a lens module, and a light beam generated by the laser light source is guided by the lens module to illuminate the color wheel.

3. The color wheel unit of claim 2, wherein the color wheel further comprising:
a light-irradiated surface to receive the light beam from the laser light source; and
a non-irradiated surface opposite to the light-irradiated surface;
wherein the light-irradiated area and the phosphor layer are positioned on the light-irradiated surface.

4. The color wheel unit of claim 1, wherein the motor further comprising an axle connected to a center of the color wheel on the non-irradiated surface.

5. The color wheel unit of claim 1, wherein the phosphor layer is circular.

6. The color wheel unit of claim 1, wherein the fan blades are arranged radially on the non-irradiated area and an included angle between any two adjacent fan blades is constant.

7. The color wheel unit of claim 6, wherein the fan blades and the color wheel are formed as a single unit.

8. The color wheel unit of claim 1, wherein the fan blades are projected from the non-irradiated surface of the color wheel.

9. The color wheel unit of claim 1, further comprising a plurality of openings defined in the color wheel corresponding to the fan blades.

10. The color wheel unit of claim I, wherein the color wheel is made of metal.
